(19) United States
(12) Patent Application Publication
(10) Pub. No.: US 2026/0083230 A1
(43) Pub. Date: Mar. 26, 2026

(54) CLEANING BASE FOR SHAVER

(71) Applicant: Yueli Group Co.,Ltd., Ningbo (CN)

(72) Inventors: Guohong FANG, Ningbo (CN); Longxuan LI, Ningbo (CN); Rong MA, Ningbo (CN)

(73) Assignee: Yueli Group Co.,Ltd., Ningbo (CN)

(21) Appl. No.: 19/096,978

(22) Filed: Apr. 1, 2025

Related U.S. Application Data
(63) Continuation of application No. PCT/CN2025/070391, filed on Jan. 3, 2025.

(30) Foreign Application Priority Data
Sep. 26, 2024 (CN) 2024113496992

(51) Int. Cl. A45D 27/46; B08B 3/02; B08B 3/14

(52) U.S. Cl. CPC A45D 27/46; B08B 3/02; B08B 3/14; B08B 2203/02

(57) ABSTRACT

The present disclosure provides a cleaning base for shaver, which comprises a cleaning mechanism (comprising a water box, a drive, spray pipes, an accommodating cavity, a backflow hole, a backflow channel and an overflow hole), a housing, a connection assembly and a magnet; the water box is below the accommodating cavity, the overflow hole is on the inner wall of the accommodating cavity, the diameter of the water box is larger than that of the accommodating cavity, the drive is between the accommodating cavity and the water box, the spray pipes are above the drive, and one end of the drive is inside the water box; the accommodating cavity houses a shaver head; the drive spays water from the water box into the accommodating cavity through the spray pipes; it can solve the problem of residue accumulation after use, and ineffective or time-consuming manual cleaning.

### CROSS-REFERENCE TO RELATED APPLICATIONS

The application claims priority to Chinese patent application No. 2024113496992, filed on Sep. 26, 2024, the entire contents of which are incorporated herein by reference.

### TECHNICAL FIELD

The present disclosure belongs to the technical field of shavers, and in particular relates to a cleaning base for a shaver.

### BACKGROUND

A shaver is a tool used to trim and remove facial hair. Its basic function is to shorten or completely remove beards or other facial hair to keep the face clean and tidy. An electric shaver is driven by electric power, and is rotary or reciprocating. The rotary electric shaver has a rounded head, which is suitable for long facial hair and can shave hair at multiple angles. The reciprocating electric shaver is provided with a set of vibrating blades to meet fine shaving demands and is usually better suited for short facial hair. The shaver design not only includes the shaving effect, but also the user's comfort and safety. A modern shaver is often provided with a non-slip handle, a comfortable blade design and an easy-to-clean construction to enhance the user experience. For users with sensitive skin or specific needs, there are also shavers specially designed to reduce skin irritation and post-shave discomfort. In general, shaver is an important tool for daily personal care and plays a key role in maintaining facial cleanliness and helping users to have better personal image.

The existing shaver heads tend to accumulate beard residues and other dirt after use, and manual cleaning may be ineffective or time-consuming.

### SUMMARY

Therefore, the present disclosure provides a cleaning base for shaver, which aims to solve such problem.

The task of the present disclosure is realized in such a way that:

The present disclosure provides a cleaning base for shaver, which comprises a cleaning mechanism, a housing, a connection assembly and a magnet; the cleaning mechanism comprises a water box, a drive, spray pipes, an accommodating cavity, a backflow hole, a backflow channel and an overflow hole; the water box is arranged below the accommodating cavity, the overflow hole is arranged on the inner wall of the accommodating cavity, the diameter of the water box is larger than that of the accommodating cavity, the drive is arranged between the accommodating cavity and the water box, the spray pipes are located above the drive, and one end of the drive is located inside the water box; the accommodating cavity houses a shaver head.

On the basis of the above technical solution, a cleaning base for shaver according to the present disclosure can be further improved as follows:

The drive spays the water from the water box into the accommodating cavity through the spray pipes, which are communicated with the accommodating cavity; the backflow hole below the accommodating cavity is communicated with the backflow channel, which is communicated with the water box; a filter screen is arranged inside the backflow channel.

Further, the housing comprises an upper cleaning shell, an outer cleaning shell and a connecting frame; the connection assembly comprises springs, a filter holder, a movable column, an outer cylinder, a cleaning bottom plate, a track groove, a torsion spring and a fixed frame; the upper cleaning shell is connected to the outer cleaning shell and is arranged above the inner part of the outer cleaning shell; the connecting frame, the filter holder, the water box and the cleaning bottom plate are sequentially connected inside the outer cleaning shell from top to bottom; the connecting frame is connected to the inner wall of the outer cleaning shell.

Further, the outer cylinder and the fixed frame are thread connected, the movable column is arranged in the outer cylinder, and the spring connected with the movable column is arranged in the outer cylinder.

Further, the inner wall of the upper cleaning shell is provided with the magnet, which is corresponding and fits to the magnetic positioning structure on the shaver handle.

Further, 2 outer cylinders are provided and are respectively arranged on the left and right sides of the connecting frame, and are attached inside the connecting frame.

Further, the inner shape of the upper cleaning shell is matched with that of the shaver head.

Further, there are 2 springs and 3 spray pipes; grooves are arranged on two corresponding sides of the upper wall of the upper cleaning shell, and the magnets are arranged in the grooves.

Compared with the prior art, the present disclosure provides a cleaning base for shaver which has the following beneficial effects: by setting the spray pipes, the cleaning base can efficiently spray water from the water box into the accommodating cavity to fully wash the shaver head. The spray pipes are designed to ensure that the water flows over all surfaces of the shaver head to effectively remove beard residues and other dirt from the shaver and improve the cleaning efficiency. The backflow holes and channel in the base design make it possible for the water to automatically return to the water box after wash. The filter screen in the backflow channel filters the water flow to ensure that impurities are removed from the water, thus keeping the water quality in the water box. This design not only improves the cleaning effect, but also reduces water waste and is beneficial to the environment protection. The design of the upper cleaning shell is matched with the magnetic positioning structure on the shaver handle, to stably fix the shaver on the cleaning base and keep the position of the head stable during cleaning. Moreover, by fitting the torsion spring and track groove, the cleaning base can realize self-resetting, which is convenient for users to operate and ensures the proper operation of all parts of the base during the cleaning. The housing of the base comprises the upper cleaning shell, outer cleaning shell and connecting frame, which are connected by threads, springs or other structures, so that the whole device is more modular in terms of assembly and maintenance. In addition, the inner shape of the upper cleaning shell matches with the shape of the shaver head, ensuring that the shaver head can be placed correctly to improve the cleaning effect. In the design, the outer cylinder and the fixed frame are thread connected to enhance the durability and stability of the whole device. The fitting between the movable column and the spring ensures the stability and comfort during use. These structural designs effectively improve the service life and stability of the base. The interior design of the base includes a removable filter holder and screen to provide convenience for routine cleaning and maintenance. The design ensures the long-term serviceability of the base, realizing simple and convenient maintenance. By setting the spray pipes and drive, the present disclosure can ensure that the water is efficiently sprayed from the water box into the accommodating cavity to fully wash the shaver head. The design of the spray pipes ensures that the water flow can cover all parts of the shaver head to provide more efficient and thorough cleaning.

To sum up, the cleaning base for shaver according to the present disclosure significantly improves the cleaning effect and user convenience of the shaver through efficient water jetting, automatic backflow filtration, convenient operation design and modular structure, and also improves the durability and environmental benefits.

It can solve the problem that the shaver heads tend to accumulate beard residues and other dirt after use, and manual cleaning may be ineffective or time-consuming.

### BRIEF DESCRIPTION OF DRAWINGS

To illustrate more clearly the technical solutions in the embodiments of the present disclosure, drawings to be used to describe the embodiments are introduced briefly below. Apparently, the drawings below are only some embodiments of the present disclosure, and those skilled in the art can derive other drawings from these drawings without creative efforts.

FIG. 1 is a schematic diagram of an interior structure of the cleaning mechanism.

FIG. 2 is an exploded view of the housing.

FIG. 3 is an exploded view of the connection assembly.

FIG. 4 is an exploded view of the components on the filter holder.

FIG. 5 is a schematic view of the overall structure of the cleaning base for shaver.

In the drawings, the parts represented by reference numbers are listed below:
1. Cleaning mechanism; 11. water box; 12. drive; 13. spray pipe; 14. accommodating cavity; 15. backflow hole; 16. backflow channel; 17. overflow hole; 2. housing; 21. upper cleaning shell; 22. outer cleaning shell; 23. connecting frame; 3. connection assembly; 31. spring; 32. filter holder; 33. movable column; 34. outer cylinder; 35. cleaning bottom plate; 36. track groove; 37. torsion spring; 38. fixed frame; 4. magnet.

### DETAILED DESCRIPTION OF THE EMBODIMENTS

In order to make clear the objectives, technical solutions and advantages of the embodiments of the present disclosure, the technical solutions in the embodiments will be clearly and completely described below, with reference to the drawings in the embodiments.

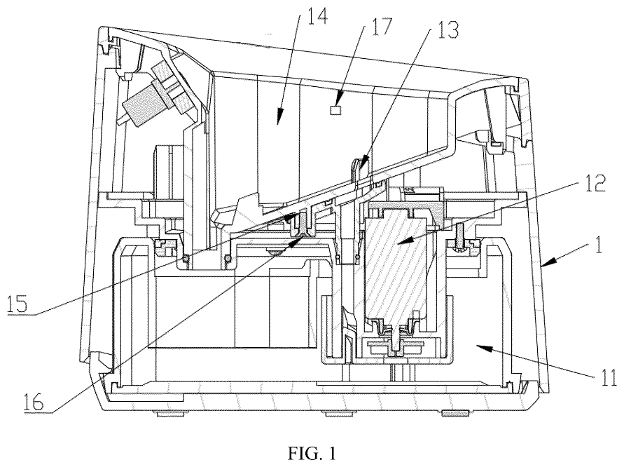

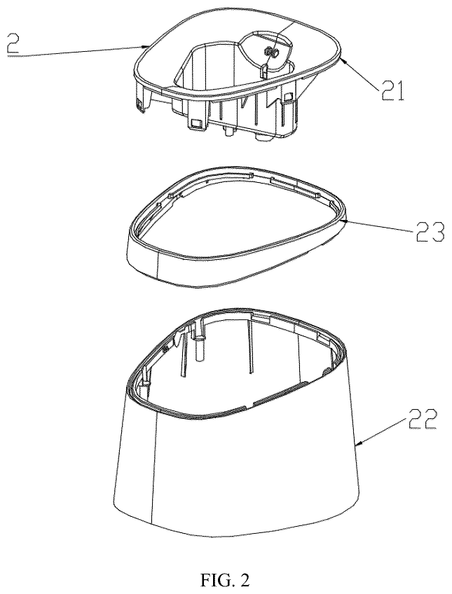

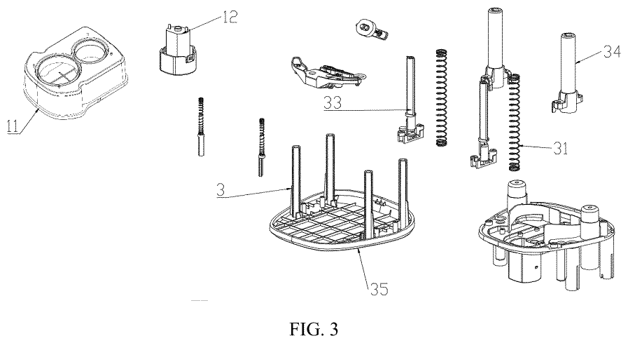

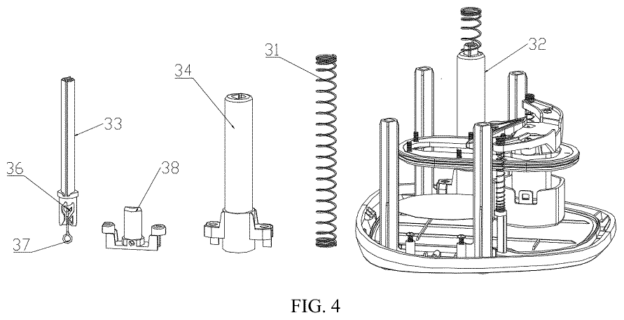

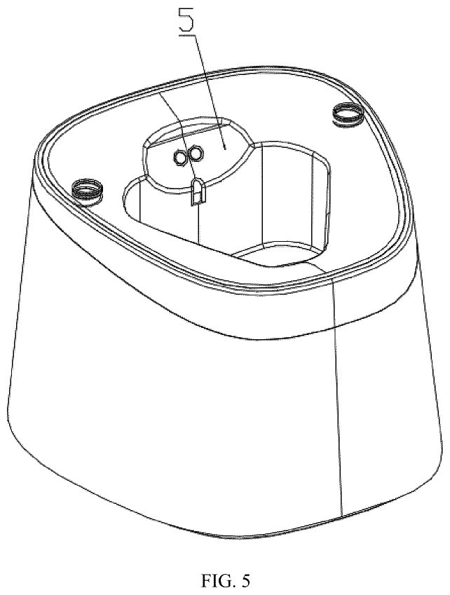

FIGS. 1-5 show a first embodiment of the cleaning base for shaver according to the present disclosure. In this embodiment, it comprises a cleaning mechanism 1, a housing 2, a connection assembly 3 and a magnet 4; the cleaning mechanism 1 comprises a water box 11, a drive 12, spray pipes 13, an accommodating cavity 14, a backflow hole 15, a backflow channel 16 and an overflow hole 17; the water box 11 is arranged below the accommodating cavity 14, the overflow hole 17 is arranged on the inner wall of the accommodating cavity 14, the diameter of the water box 11 is larger than that of the accommodating cavity 14, the drive 12 is arranged between the accommodating cavity 14 and the water box 11, the spray pipes 13 are located above the drive 12, and one end of the drive 12 is located inside the water box 11; the accommodating cavity 14 houses a shaver head.

During use, the outer cylinder 34 is screw-connected with the fixed frame 38, and the movable column 33 is arranged in the outer cylinder 34. So, the outer cylinder 34 is in a stationary state. The spring 31 connected with the movable column 33 is also arranged in the outer cylinder 34. When pressing the upper cleaning shell 21 by hand, the outer cleaning shell 22 will drive the connecting frame 23 to generate a downward pressing action, and then the connecting frame 23 slides down along the outer cylinders 34 on both sides. During sliding, the track groove of the torsion spring 37 will rise from the bottom and then fall down and be engaged in the clamping position. When pressing the upper cleaning shell 21 again, the track groove of the torsion spring 37 will rise up and be disengaged from the clamping position, and then fall back to the initial position, while the connecting frame 23 and the outer cleaning shell return to the initial position. The drive 12 in the water box 11 rotates and sprays the water from the water box 11 into the accommodating cavity 14 through three spray pipes 13, to flush the shaver head in the accommodating cavity 14. After flushing, the water will flow through the backflow hole 15 into the backflow channel 16, and then return to the water box 11 again, after being filtered by the filter screen.

In the above technical solution, the drive 12 sprays the water from the water box 11 into the accommodating cavity 14 through the spray pipes 13, which are communicated with the accommodating cavity 14; the backflow hole 15 arranged below the accommodating cavity 14 is communicated with the backflow channel 16, which is communicated with the water box 11; the filter screen is arranged inside the backflow channel 16.

Further, in the above technical solution, the housing 2 comprises the upper cleaning shell 21, the outer cleaning shell 22 and the connecting frame 23; the connection assembly 3 comprises the springs 31, the filter holder 32, the movable column 33, the outer cylinder 34, the cleaning bottom plate 35, the track groove 36, the torsion spring 37 and the fixed frame 38; the upper cleaning shell 21 is connected to the outer cleaning shell 22, and is arranged above the inner part of the outer cleaning shell 22; the connecting frame 23, the filter holder 32, the water box 11 and the cleaning bottom plate 35 are sequentially connected inside the outer cleaning shell 22 from top to bottom; the connecting frame 23 is connected to the inner wall of the outer cleaning shell 22.

Further, in the above technical solution, the outer cylinder 34 and the fixed frame 38 are thread connected; the movable column 33 is arranged in the outer cylinder 34, and the spring 31 connected with the movable column 33 is arranged in the outer cylinder 34.

Further, in the above technical solution, the inner wall of the upper cleaning shell 21 is provided with the magnet 4, which is corresponding and fits to the magnetic positioning structure on the shaver handle.

Further, in the above technical solution, two outer cylinders 34 are provided and are respectively arranged on left and right sides of the connecting frame 23, and the outer cylinders 34 are attached inside the connecting frame 23.

Further, in the above technical solution, the inner shape of the upper cleaning shell 21 is matched with that of the shaver head.

Further, in the above technical solution, there are two springs 31 and three spray pipes 13; grooves are arranged on two corresponding sides of the upper wall of the upper cleaning shell 21, and the magnets 4 are arranged in the grooves.

Specifically, the principle of the present disclosure is that the outer cylinder 34 is screw-connected with the fixed frame 38, and the movable column 33 is arranged in the outer cylinder 34. So, the outer cylinder 34 is in a stationary state. The spring 31 connected with the movable column 33 is also arranged in the outer cylinder 34. When pressing the upper cleaning shell 21 by hand, the outer cleaning shell 22 will drive the connecting frame 23 to generate a downward pressing action, and then the connecting frame 23 slides down along the outer cylinders 34 on both sides. During sliding, the track groove of the torsion spring 37 will rise from the bottom and then fall down and be engaged in the clamping position. When pressing the upper cleaning shell 21 again, the track groove of the torsion spring 37 will rise up and be disengaged from the clamping position, and then fall back to the initial position, while the connecting frame 23 and the outer cleaning shell return to the initial position. The drive 12 in the water box 11 rotates and sprays the water from the water box 11 into the accommodating cavity 14 through three spray pipes 13, to flush the shaver head in the accommodating cavity 14. After flushing, the water will flow through the backflow hole 15 into the backflow channel 16, and then return to the water box 11 again, after being filtered by the filter screen.

What is claimed is:

1. A cleaning base for shaver, wherein it comprises a cleaning mechanism (1), a housing (2), a connection assembly (3) and a magnet (4); the cleaning mechanism (1) comprises a water box (11), a drive (12), spray pipes (13), an accommodating cavity (14), a backflow hole (15), a backflow channel (16) and an overflow hole (17); the water box (11) is arranged below the accommodating cavity (14), the overflow hole (17) is arranged on the inner wall of the accommodating cavity (14), the diameter of the water box (11) is larger than that of the accommodating cavity (14), the drive (12) is arranged between the accommodating cavity (14) and the water box (11), the spray pipes (13) are located above the drive (12), and one end of the drive (12) is located inside the water box (11); the accommodating cavity (14) houses a shaver head.

2. The cleaning base for shaver according to claim 1, wherein the drive (12) sprays water from the water box (11) into the accommodating cavity (14) through the spray pipes (13), which are communicated with the accommodating cavity (14); the backflow hole (15) arranged below the accommodating cavity (14) is communicated with the backflow channel (16) that is communicated with the water box (11); the filter screen is arranged inside the backflow channel (16).

3. The cleaning base for shaver according to claim 2, wherein the housing (2) comprises an upper cleaning shell (21), an outer cleaning shell (22) and a connecting frame (23); the connection assembly (3) comprises springs (31), a filter holder (32), a movable column (33), an outer cylinder (34), a cleaning bottom plate (35), a track groove (36), a torsion spring (37) and a fixed frame (38); the upper cleaning shell (21) is connected to the outer cleaning shell (22) and is arranged above the inner part of the outer cleaning shell (22); the connecting frame (23), the filter holder (32), the water box (11) and the cleaning bottom plate (35) are sequentially connected inside the outer cleaning shell (22) from top to bottom; the connecting frame (23) is connected to the inner wall of the outer cleaning shell (22).

4. The cleaning base for shaver according to claim 3, wherein the outer cylinder (34) and the fixed frame (38) are thread connected; the movable column (33) is arranged in the outer cylinder (34) and the spring (31) connected with the movable column (33) is arranged in the outer cylinder (34).

5. The cleaning base for shaver according to claim 4, wherein the inner wall of the upper cleaning shell (21) is provided with the magnet (4), which is corresponding and fits to the magnetic positioning structure on the shaver handle.

6. The cleaning base for shaver according to claim 5, wherein two outer cylinders (34) are provided and are respectively arranged on left and right sides of the connecting frame (23), and the outer cylinders (34) are attached inside the connecting frame (23).

7. The cleaning base for shaver according to claim 6, wherein the inner shape of the upper cleaning shell (21) is matched with the shape of the shaver head.

8. The cleaning base for shaver according to claim 7, wherein 2 springs (31) and 3 spray pipes (13) are provided; grooves are arranged on two corresponding sides of the upper wall of the upper cleaning shell (21), and the magnets (4) are arranged in the grooves.
